(19) United States
(12) Patent Application Publication
(10) Pub. No.: US 2001/0034586 A1
(43) Pub. Date: Oct. 25, 2001

(54) Method for monitoring and controlling home security system and other functions via a network

(76) Inventors: David S. Ewert, Lakewood, CO (US); David L. Houston, Lakewood, CO (US); Willem A. Scheuder, Evergreen, CO (US); James Rogers, Loveland, CO (US)

Correspondence Address: DORSEY & WHITNEY, LLP, SUITE 4700, 370 SEVENTEENTH STREET, DENVER, CO, 80202-5647, US

(21) Appl. No.: 09/800,352

(22) Filed: Mar. 5, 2001

Related U.S. Application Data
(60) Provisional application No. 60/186,812, filed on Mar. 3, 2000.

(51) Int. Cl. G06F 11/00; G06F 15/00

(52) U.S. Cl. 702/188

(57) ABSTRACT

A system and method for monitoring a property and controlling electrical devices located at the property via a network is disclosed. The system may include a controller, a monitoring device and a device having a first state and a second state. The controller receives an image from the monitoring device and transmits the image to a network in response to a request for the image, and changes the state of the device in response to a request for the change in state. The controller may also store the image in a data storage device for future access, and may also provide notification of any problems perceived by the system. Notification may be by e-mail message, via telephone page, or audible indicator on or off the premises.

### CROSS-REFERENCE TO RELATED PATENT APPLICATIONS

This application claims the benefit of U.S. patent application Ser. No. 60/186,812 entitled “Method for Monitoring Home Security System and Other Functions Via the Internet” and filed Mar. 3, 2000, which is hereby incorporated by reference.

### FIELD OF THE INVENTION

The present invention relates to computer-implemented methods for monitoring and controlling home security and other physical plant functions of a household. The present invention specifically utilizes a network such as the Internet or an intranet to allow for remote implementation of these controls.

### BACKGROUND OF THE INVENTION

Electronic devices such as wireless phones, pagers, and laptop computers have increased the accessibility of travelers and have made travel more convenient. Travelers often, however, cannot sufficiently control their property while they are traveling and have to hire someone to take care of their property while they are away. Although home security systems exist to notify the traveler of problems that have been detected, they do not provide the traveler the ability to remotely monitor video or audio images and control devices on their property such as the heating/cooling system, sprinkler system, appliances, television, video recorders, etc.

### SUMMARY OF THE INVENTION

The present invention provides a system for monitoring a property and controlling electrical devices located at the property via a network. The system includes a controller adapted to receive a request from the network, a monitoring device adapted to provide an electronic image to the controller and a device having a first state and a second state. The controller is adapted to transmit the electronic image to the network in response to a request for the electronic image from the network. The controller is further adapted to change the state of the device from the first state to the second state in response to a request for a change in state from the network.

Controllable devices, for example, may include lights, gates, security systems, surveillance cameras, heating and cooling systems, audio/visual equipment, appliances, watering systems, and doors and windows. The method disclosed allows a user to view in real time the current status of any electronically linked function, including audio and video surveillance.

The present invention further provides a system for monitoring a property via a network including a data storage device, a monitoring device adapted to provide an electronic image and a controller. The controller is adapted to receive the electronic image from the monitoring device and store the electronic image in the data storage device. The controller is further adapted to provide the electronic image from the data storage device to the network in response to a request from the network for the electronic image from the network. The data storage device may be any type of data storage device known in the art such as memory, a disk drive or a tape drive. The storage of the electronic image allows for review of the physical plant functions over a period or for any given time in the past, including surveillance footage, to the limits of the data storage device. In the disclosed embodiment, this period may be up to a month in length.

The present invention further provides notification of any problems perceived by the system. Such problems could include security encroachments, power outages, etc. Notification may be by e-mail message, via telephone page, or audible indicator on or off the premises. Such notification may include, if applicable, images of the triggered problem captured on camera.

The present invention also includes a method for monitoring and controlling functions of a property over a network including the steps of recording an electronic image, receiving a request from the network, providing the electronic image to the network and changing a state of a device from a first state to a second state in response to the request.

### BRIEF DESCRIPTION OF THE DRAWINGS

The preferred embodiments of the invention will be described in detail with reference to the following figures, in which like numerals refer to like elements, and wherein:

FIG. 1 is a block diagram of one embodiment of a system of the present invention connected to a network;

FIG. 2 is a block diagram of an alternative embodiment of a system showing various components that interact to provide the control functions of the present invention;

FIG. 3 is a flow control diagram for the GRABD component of the embodiment shown in FIG. 2;

FIG. 4 is a flow control diagram for the CONTROLD component of the embodiment shown in FIG. 2;

FIG. 5 is a flow control diagram for the IFXD component of the embodiment shown in FIG. 2;

FIG. 6 is a flow control diagram for the EXECD component of the embodiment shown in FIG. 2; and

FIG. 7 is a flow control diagram for the HTTPD component of the embodiment shown in FIG. 2.

### DETAILED DESCRIPTION OF THE INVENTION

The system of the present invention allows a user to remotely monitor and control electronically accessible physical plant functions of his or her property, be it a home, business, vacation residence, or other property, over a network such as the Internet or an intranet. Monitoring and control is preferably achieved through the interface of a web browser with control software operations. Such an interface may allow a user access to the functions of his or her property from virtually anywhere in the world.

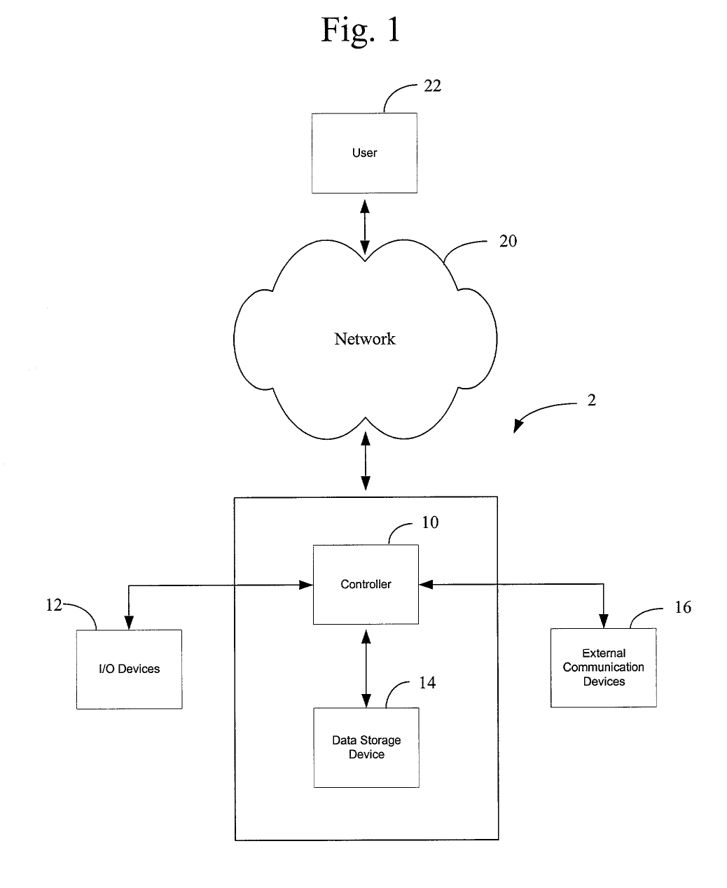

For example, as shown in FIG. 1, the system 2 of the present invention may include a controller 10, I/O devices 12, a data storage device 14 and an external communication device 16. In this embodiment, the controller 10 monitors the I/O devices 12 and stores information from these devices in the data storage device 14, which may be memory, a disk drive, a tape drive or any other data storage device known in the art. The I/O devices 12, for example, may include devices such as digital or analog cameras, microphones, smoke detectors, gas sensors, heating and cooling systems, appliances, motion sensors, temperature sensors, etc. The system 2 is capable of being connected to a network 20 such as the Internet or an intranet from which a user 22 may remotely access the system 2. The user 22 can monitor current statuses or images directly from the I/O devices 12 or can monitor recorded information from the data storage device 14. The data storage device 14, for example, may provide access to stored images and/or other sensor or device statuses for at least a day, a week, a month or a year.

The controller 10 may also provide notification of any problems perceived by the system 2. For example, the controller 10 may notify the fire department, police department, property owner or other contact of a perceived problem. Such problems could include smoke or gas detections, security encroachments, power outages, etc. The system 2 may include an external communication device 16 from which the controller 10 can provide such a notification, or the controller 10 may send a notification directly over the network 20. Notification, for example, may be by e-mail, via telephone page, telephone call, fax, audible indicator on or off the premises, or any other notification procedure known in the art. Such notification may include, if applicable, images of the triggered problem captured on camera.

The controller 10 may be implemented on a programmed general purpose computer, a special purpose computer, a programmed microprocessor or micro-controller and peripheral integrated circuit elements, an ASIC or other integrated circuit, a digital signal processor, a hardwired electronic or logic circuit such as a discrete element circuit, a programmable logic device such as a PLD, PLA, FPGA, PAL, or the like. In general, any device capable of implementing a finite state machine that can implement the functions described above can be used to implement the controller 10.

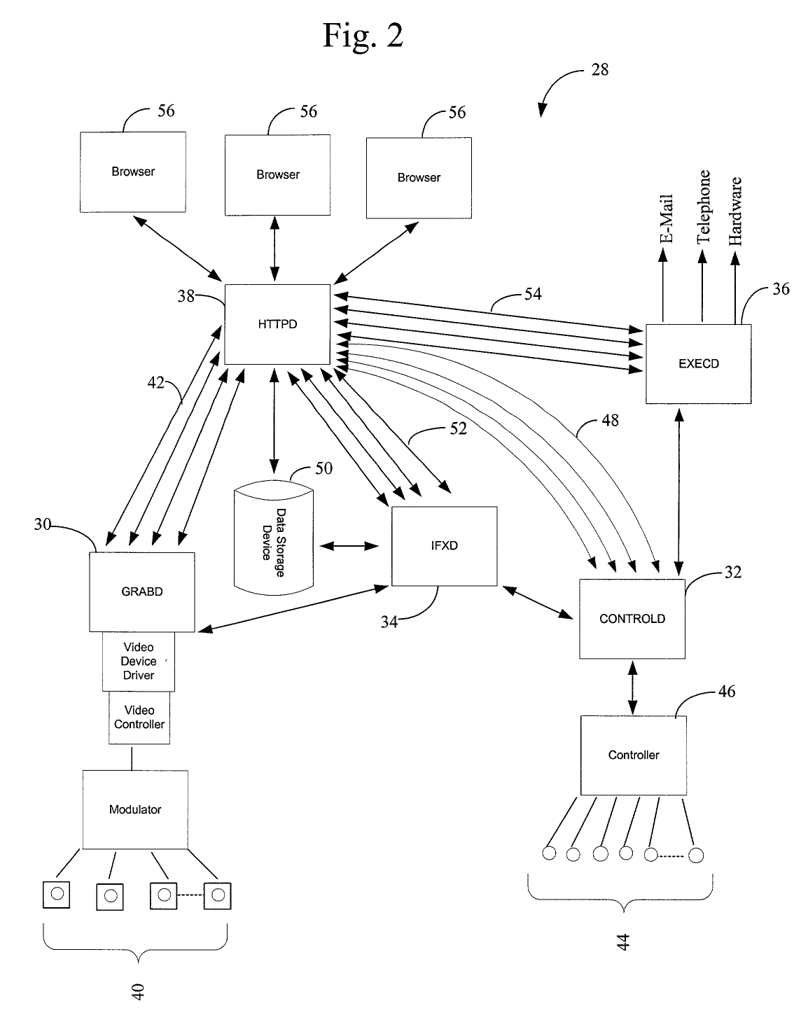

In another embodiment, such as shown in FIGS. 2-7, the system 28 may include multiple interconnect components. For example, the system 28 may include the following five interconnect components:

1) GRABD 30;

2) CONTROLD 32;

3) IFXD 34;

4) EXECD 36; and

5) HTTPD 38.

Each component in the system 28 can be implemented as a computer program that will run as a separate process, or two or more of the components may be implemented together in a computer program that will run as a single process.

The system 28 controls attached devices and other software under user control, and provides feedback to the user. Examples of such control are to use a web browser to activate a security system, changing the field of view of a camera, or to turn lights on or off. An example of feedback includes taking visual images from cameras and returning them to a user's browser, either immediately or by buffering them and returning the image at a later time upon request. Another example is to capture a video image in response to an event such as a door opening, and then to present the image to a user via a web browser or e-mail.

The GRABD component 30 includes software and hardware to capture images from one or more cameras 40. GRABD 30 is configured to capture images at the desired resolution from each of the connected cameras 40 upon request. Requests to GRABD 30 are sent over a network connection 42 such as TCP/IP. GRABD 30 then captures the image, optionally converts the image to a standard format, such as JPEG, and sends the image back to the requestor over the network connection 42.

The CONTROLD component 32 includes software and controller hardware to perform control over attached I/O hardware 44 such as controls and sensors. One example of controller hardware that may be used is a JDS Stargate Controller. CONTROLD 32 is configured to transmit requests to the attached controller 46 and to receive replies from the controller 46. Requests to CONTROLD 32 can be sent over a network connection 48 such as UDP/IP. Requests may include commands to be sent to the attached controller 46 as well as the number of replies expected. These requests can be queued by CONTROLD 32 and sent to the attached controller 46 when possible. Replies received from the attached controller 46 can be buffered and sent back to the requester over the same network connection 48. Where no reply is expected an acknowledgment can be sent immediately.

The attached controller 46 can forward requests to I/O hardware 44 though direct control (energizing or de-energizing circuits), as well as other protocols such as X.10 or other digital or analog connections. This I/O hardware 44 may include security sensors, audio/visual equipment, heating and air conditioning controls, thermometers, humidity sensors, light controls, appliances, gates, soil moisture sensors, watering systems, and other sensors or controllable physical plant systems.

The CONTROLD component 32 can also accept unsolicited messages from the attached controller 46. A reserved header in the message, for example, may be used to identify these messages. CONTROLD 32 can be configured to forward these unsolicited messages to other components, particularly IFXD 34 and EXECD 36. These unsolicited messages may consist of status updates on the functions of various I/O hardware 44 or activation alerts from any attached sensors of the I/O hardware 44. These unsolicited messages may also be directed to IFXD 34 for the performance of functions by that component.

The IFXD component 34 includes software to collect images. At predetermined intervals, IFXD 34 requests images from GRABD 30 and statuses CONTROLD 32 from and saves the images to a data storage device 50 such as memory, a disk drive, a tape drive or any other data storage device known in the art. The intervals for each camera 40 and each piece of I/O hardware 44 may be selected to save a desired history for that particular piece of equipment. For example, an image from a camera may be stored once per second while a soil moisture sensor may be recorded once per day to determine if a watering system should be turned on that day. Unsolicited messages from the attached controller 46 can also be forwarded via CONTROLD 32 to IFXD 34. These messages may contain a request for IFXD 34 to capture an image from a particular camera 40 and a reason for doing so. In response IFXD 34 will capture these images and save them to a data storage device 50 in addition to its regularly collected images. For example, if CONTROLD 32 detects a predetermined event, one or more audio and/or video images corresponding to the location of the event may be taken and stored in the data storage device 50.

Requests can be sent to IFXD 34 for images that satisfy various criteria such as times, reasons, channels, and the like. These requests can be received over a network connection 52 such as TCP/IP. IFXD 34 can respond with a list of file names that satisfy these criteria, if any, or may provide one or more files directly over the network connection 52. Finally, IFXD 34 can manage image files on the data storage device 50, including purging images that satisfy aging or other criteria.

The EXECD component 36 includes software to execute external programs upon request. Such requests can be received over a network connection 54 such as TCP/IP. For example, EXECD 36 can be used when an unsolicited message is received from the attached controller 46 in response to a sensor input. The message may be directed to EXECD 36 and, in response, EXECD 36 can send one or more notifications to alert a person or persons that such an event has occurred. For example, EXECD 36 can send a notification by e-mail, via telephone page, telephone call, fax, audible indicator on or off the premises or any other notification procedure known in the art. Such notification may include, if applicable, images of the triggered problem captured on one or more of the cameras 40. EXECD 36 can be configured to respond with the appropriate action to each such message that can be received. The EXECD component 36 can perform any action that can occur under software control such as e-mailing, paging, telephone calls, activation of other hardware, and so on.

The HTTPD component 38 includes software that is run in response to user requests. User requests can be received via a network using a web browser 56, e-mail message, direct keyboard or mouse input, or software control. The HTTPD component 38 can receive multiple requests in parallel. These requests are formulated in the appropriate manner and forwarded to other components of the system. For example, requests for actions for controlling devices such as lights can be forwarded to CONTROLD 32, which in turn uses the attached controller to perform the action. Acknowledgment of the action as well as status information can be returned to HTTPD 38 from CONTROLD 32. Requests for actions that can occur under software control are forwarded from HTTPD 38 to EXECD 36 for implementation. Replies, if any, can also be returned.

Requests for images may fall into at least two categories. For example, requests can be directly sent to GRABD 30 for current images or may be sent to IFXD 34 for stored images. GRABD 30 may fulfill a direct request as previously described. The IFXD component 34 may retrieve the image from the data storage device 50 and provide the image to the requestor directly, or the IFXD component 34 may respond by providing a list of files stored in the data storage device 50 that satisfies the request, which HTTPD 38 may then retrieve directly from memory.

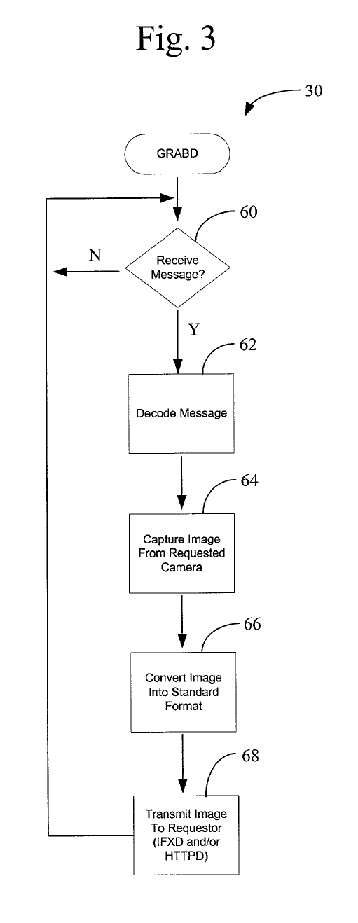

FIG. 3 shows a flow control diagram of the GRABD component 30. In step 60, the GRABD component 30 waits until a message is received and then decodes that message in step 62. Then, the GRABD component 30 captures an image from the requested camera in step 64. The image may be a single frame or a sequence of frames taken at a particular interval depending upon the quality of the video desired. Alternatively, the image may be an audio signal taken from a microphone instead of a camera. The image may optionally be converted into a standard format by the GRABD component 30 in step 66. Finally, the GRABD component 30 transmits the image to the requestor in step 68. In one embodiment, such as shown in FIG. 2, the requestor may be, for example, the IFXD component 34 and/or the HTTPD component 38.

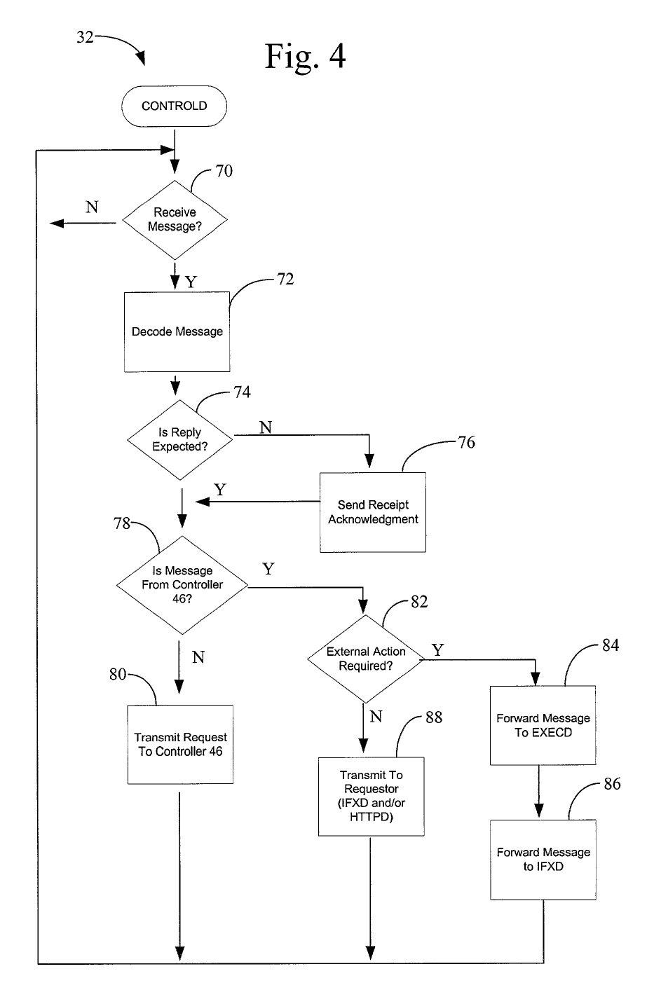

FIG. 4 shows a flow control diagram of the CONTROLD component 32. In step 70, the CONTROLD component 32 waits until a message is received and then decodes that message in step 72. Then, the CONTROLD component 32 determines if a reply is expected in step 74. If no reply is expected, the CONTROLD component 32 sends a receipt acknowledgment in step 76. Then, the CONTROLD component 32 determines if the message is from the attached controller 46 in step 78. If it is not from the attached controller 46, then the CONTROLD component 32 transmits the request to the attached controller 46 in step 80 and returns to the beginning of the CONTROLD component 32 at step 70.

If the message is from the attached controller 46, however, the CONTROLD component 32 determines if an external action is required in step 82. If an external action is required, the CONTROLD component 32 forwards the message to the EXECD component 36 in step 84, and may optionally forward the message to the IFXD component 34 in step 86 if a history of the event is desired. Also, if desired, the detection of an event by the CONTROLD component 32 may trigger a request for an image to be taken by a camera or microphone in the location where the event was detected and stored by the IFXD component 34. The IFXD component 34 may, for example, request the GRABD component 30 to take a single video image, a sequence of video images and/or an audio image on one or more sides of a door or window when the door or window is detected to be open.

If an external action is not required, the CONTROLD component 32 transmits the message to the requestor in step 88. In one embodiment, such as shown in FIG. 2, the requestor may be, for example, the IFXD component 34 and/or the HTTPD component 38. Again, if a history is desired, the message may be stored in the data storage device 50 by the IFXD component 34, and the IFXD component 34 may also request and store an image taken in the area of the event as described above.

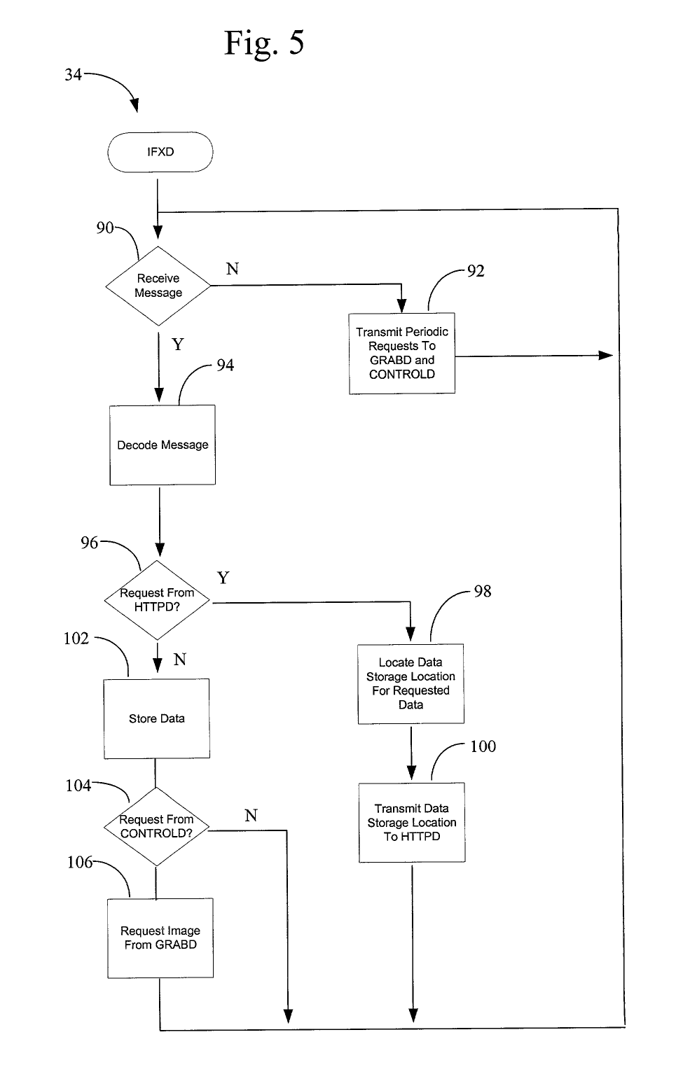

FIG. 5 shows a flow control diagram of the IFXD component 34. In step 90, the IFXD component 34 determines if a message has been received. If no message is received, the IFXD component 34 transmits periodic requests to the GRABD component 30 and the CONTROLD component 32 in step 92. These requests may be made at any periodic interval in order to create a desired storage history such as once per second, once per minute, once per hour or any other increment. If the IFXD component 34 determines that a message has been received, however, the IFXD component 34 decodes that message in step 94.

Then, the IFXD component 32 determines whether the request was from the HTTPD component 38 in step 96. If the request is from the HTTPD component 38, the IFXD component 34 locates the location in the data storage device 50 for the requested data and transmits the requested storage location to the HTTPD component 38 in steps 98 and 100. The HTTPD component 34 then may access the data directly from the data storage device 50. Alternatively, the IFXD component 34 may retrieve the requested data from the data storage device 50 and forward the data directly to the HTTPD component 38. If the request is not from the HTTPD component 38, the IFXD component 34 stores the data received in step 102. If the request is from the CONTROLD component 32, the IFXD component 34 may also optionally request a video or audio image from the GRABD component 30 and store it in the data storage device 50 corresponding to the particular event received from the CONTROLD component 32 in steps 104 and 106.

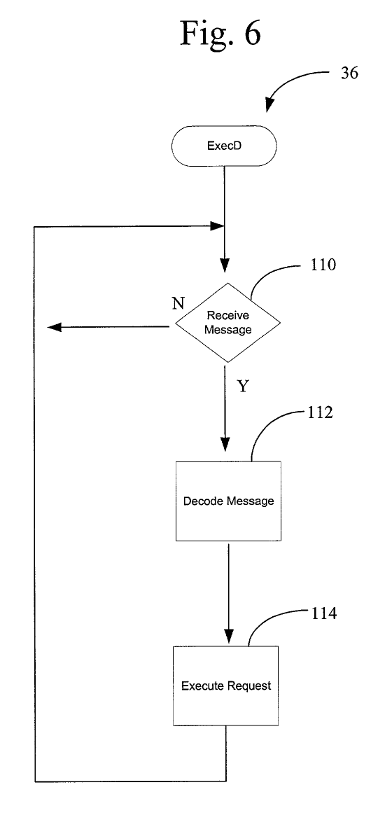

FIG. 6 shows a flow control diagram of the EXECD component 36. In step 110, the EXECD component 36 waits until a message is received and then decodes that message in step 112. Then, the EXECD component 36 executes the request in step 114 and returns to the beginning of the EXECD component 36 at step 110.

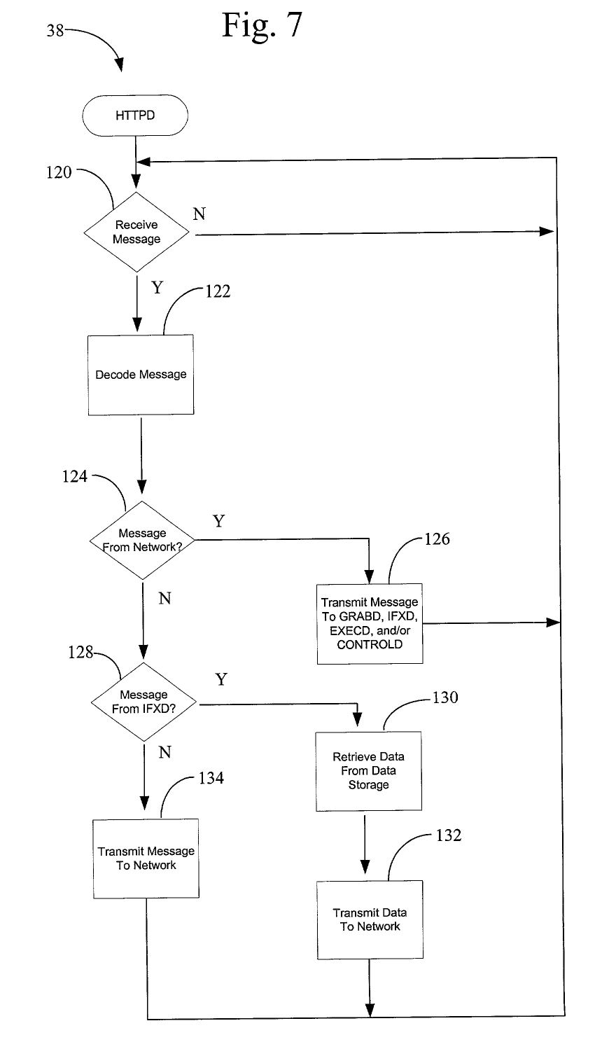

FIG. 7 shows a flow control diagram of the HTTPD component 38. In step 120, the HTTPD component 38 waits until a message is received and then decodes that message in step 122. Then, the HTTPD component 38 determines if the message is from the network or from the system in step 124. If the message is a request from the network, the HTTPD component 38 transmits the message to the appropriate component in step 126. If the message is from within the system, however, the HTTPD component 38 determines if the message is from the IFXD component 34 in step 128. If the message is from the IFXD component 34, the HTTPD component 38 retrieves the data from the storage location in the data storage device 50 provided by the IFXD component 34 in step 130 and forwards that data to the network in step 132. If the IFXD component 34 provides the data directly to the HTTPD component 38 as described above, however, the HTTPD component 38 may forward this data directly to the network. If the message is not from the IFXD component 34, however, the HTTPD component 38 transmits the message to the network in step 134 and then returns to the beginning of the HTTPD component 38 at step 120.

While the invention has been described in conjunction with the specific embodiments outlined above, it is evident that many alternatives, modifications, and variations will be apparent to those skilled in the art. Accordingly, the preferred embodiments of the invention are intended to be illustrative and not limiting. Various changes may be made without departing from the spirit and scope of the invention as defined in the following claims.

What is claimed is:

1. A system for monitoring a property and controlling electrical devices located at the property via a network, the system comprising:
(a) a controller adapted to receive a request via the network;
(b) a monitoring device adapted to provide an electronic image to said controller; and
(c) an device having a first state and a second state, wherein said controller is adapted to transmit said electronic image to the network in response to a request for said electronic image from the network and said controller is further adapted to change said device from said first state to said second state in response to a request for a change in state from the network.

2. The system of claim 1, wherein the electronic image is selected from the group of: a digital video image, an analog video image, a sequence of digital video images, a sequence of analog video images, a digital audio image, and an analog audio image.

3. The system of claim 1, further comprising a data storage element for storing said electronic image, said controller being adapted to retrieve said electronic image from said data storage element and transmit said electronic image to the network in response to said request.

4. The system of claim 3, wherein said data storage device is selected from the group consisting of: a disk drive, a tape drive, and a memory.

5. The system of claim 1, further comprising a data storage element connected to the controller for storing said electronic image, said controller being adapted to transmit a storage location for said electronic image in said data storage device to the network, said data storage device being accessible from the network.

6. The system of claim 5, wherein said data storage device is selected from the group consisting of: a disk drive, a tape drive, and a memory.

7. The system of claim 1, wherein said device includes one or more of the group consisting of: a security system, a light, a thermostat, a heating system, a cooling system, a sprinkler system, a television, a door, a window, a gate, a surveillance camera, audio/visual equipment, an appliance, and a fireplace.

8. The system of claim 1, further comprising a sensor for detecting a predetermined condition, said controller being adapted to transmit a notification message in response to said sensor detecting said predetermined condition.

9. The system of claim 8, wherein said controller transmits said notification message via one or more of the group consisting of: an e-mail, a pager, a telephone, the network, an audible indication on the property, and an audible indication off the property.

10. The system of claim 8, wherein said predetermined condition includes one or more of the group consisting of: a temperature, a movement, smoke, gas, a door opening, and a window opening.

11. The system of claim 8, wherein said notification message includes said electronic image and said electronic image corresponds to a time and location when said sensor detected said predetermined condition.

12. A system for monitoring a property via a network, the system comprising:
(a) a data storage device;
(b) a monitoring device adapted to provide an electronic image to said controller; and
(c) a controller adapted to receive said electronic image from said monitoring device and store said electronic image in said data storage device, said controller further adapted to provide said electronic image to the network in response to a request for said electronic image from the network.

13. The system of claim 12, wherein said controller is adapted to retrieve said electronic image from said data storage device and transmit said electronic image to the network in response to said request for said electronic image from the network.

14. The system of claim 12, wherein said controller is adapted to transmit a storage location for said electronic image in said data storage device to the network, said data storage device being accessible from the network.

15. The system of claim 14, further comprising a sensor for detecting a predetermined condition, said controller being adapted to transmit a notification message in response to said sensor detecting said predetermined condition.

16. The system of claim 15, wherein said controller retrieves said electronic image from said data storage device corresponding to a time and location when said sensor detected said predetermined condition.

17. The system of claim 15, wherein said controller transmits said notification message via one or more of the group consisting of: an e-mail, a pager, a telephone, the network, an audible indication on the property, and an audible indication off the property.

18. A method for monitoring and controlling functions of a property over a network, the method comprising the steps of:
(a) recording an electronic image;
(b) receiving a request from the network;
(c) providing said electronic image to the network; and
(d) changing a state of a device from a first state to a second state in response to said request.

19. The method of claim 18, further comprising the steps of:
(e) storing said electronic image; and
(f) retrieving said electronic image in response to said request received from the network.

20. The method of claim 18, further comprising the steps of:
(e) storing said electronic image; and
(f) providing a storage location for said electronic image to the network in response to said request received from the network.
